(19) United States
(12) Patent Application Publication
(10) Pub. No.: US 2009/0032749 A1
(43) Pub. Date: Feb. 5, 2009

(54) Regulating Valve and Fuel Cell System

(76) Inventor: Yoshio Ishihara, Aichi (JP)

Correspondence Address: KENYON & KENYON LLP, 1500 K STREET N.W., SUITE 700, WASHINGTON, DC, 20005, US

(21) Appl. No.: 12/223,659

(22) PCT Filed: Mar. 5, 2007
(86) PCT No.: PCT/JP2007/054736

§ 371 Date: Aug. 6, 2008

(30) Foreign Application Priority Data
Mar. 3, 2006 (JP) 2006-057374

(51) Int. Cl. F16K 31/122

(52) U.S. Cl. 251/73

(57) ABSTRACT

A regulating valve includes a cylinder, a piston provided inside the cylinder and displaced in a predetermined direction when a pressure of a hydrogen gas existing on a downstream side of a fuel supply path is smaller than a predetermined pressure, and a valve body which is provided inside the cylinder and which abuts on the piston and is pushed and displaced by the piston to open the fuel supply path at a time when the piston is displaced in the predetermined direction, wherein an abutment portion between the piston and the valve body is provided with a rubber member as an impact absorbing member.

### BACKGROUND

The present invention relates to a regulating valve and a fuel cell system. More particularly, it relates to a technology effective for improvement of durability of a regulating valve.

In recent years, a fuel cell system has received attention in which a fuel cell to generate a power owing to an electrochemical reaction between a fuel gas and an oxidizing gas (hereinafter referred to as a reactive gas) is used as an energy source. In the fuel cell system, the fuel gas having a high pressure is supplied from a fuel tank to the fuel cell, and air is pressurized and supplied to the fuel cell where the electrochemical reaction between the fuel gas and the oxidizing gas is performed to generate an electromotive force and heat.

In the fuel cell system, a fuel supply path which supplies the fuel gas to the fuel cell is provided with a regulating valve which reduces (adjusts) a pressure of the fuel gas having a high pressure. The high-pressure fuel gas stored in the fuel tank is adjusted into an appropriate pressure by the regulating valve, and supplied to the fuel cell.

The regulating valve includes a cylinder into which the fuel gas is introduced, a piston disposed in the cylinder and a valve body similarly disposed in the cylinder. When a pressure of the fuel gas on a downstream side from the cylinder is smaller than a predetermined pressure, the piston is displaced in a predetermined direction (a valve opening direction). When the piston is displaced, the valve body abuts on the piston. The valve body is pushed by the piston and displaced to open the fuel supply path (e.g., see Japanese Patent Application Laid-Open No. 9-112731).

### SUMMARY

In a regulating valve provided in a fuel cell system, in a case where with increase of an amount of power to be generated as required from a user, consumption of a hydrogen gas in a fuel cell rapidly increases and a pressure of the hydrogen gas on a downstream side from the regulating valve, that is, on a fuel cell side rapidly lowers, impact during collision between a valve body and a piston is large, and the valve body is sometimes worn or deformed owing to the impact.

To solve the problem, an object of the present invention is to provide a regulating valve capable of inhibiting generation of wear and deformation of a valve body even in a case where the valve body collides with a piston in the regulating valve installed in a fluid channel.

A regulating valve of the present invention is a regulating valve which is installed in a fluid channel to adjust a fluid pressure, comprising, in a cylinder into which a fluid is introduced, a piston which is displaced in a predetermined direction at a time when the fluid pressure on a downstream side from the cylinder becomes smaller than a predetermined pressure; a valve body which abuts on the piston at a time when the piston is displaced in the predetermined direction, whereby the valve body is pushed by the piston, and is displaced to change a valve open degree; and an impact absorbing member provided in an abutment portion between the piston and the valve body.

Moreover, a fuel cell system of the present invention is a fuel cell system comprising: a fuel cell which receives gas supply to generate a power; and a gas channel through which a gas to be supplied to or discharged from the fuel cell flows, wherein the regulating valve having the above constitution is installed in any position along the gas channel.

The regulating valve may be installed in a fuel gas supply channel which supplies, for example, a fuel gas to the fuel cell in the gas channel.

According to the above constitution, the impact absorbing member is provided in the abutment portion between the valve body and the piston, so that impact during collision of the valve body with the piston can be relaxed.

According to the present invention, the impact absorbing member is provided in the abutment portion between the valve body and the piston, so that the impact during the collision of the valve body with the piston can be relaxed. Therefore, generation of wear and deformation of the valve body can be inhibited.

### DESCRIPTION OF DRAWINGS

FIG. 1 is a system constitution diagram schematically showing one embodiment of a fuel cell system according to the present invention;

FIG. 2 is a sectional view showing a structure of a regulating valve provided in the fuel cell system of FIG. 1 and showing a state in which a valve body closes a fuel supply path;

FIG. 3 is a sectional view showing a structure of the regulating valve provided in the fuel cell system of FIG. 1 and showing a state in which the valve body opens the fuel supply path; and

FIG. 4 is a sectional view showing another embodiment of the regulating valve provided in the fuel cell system of FIG. 1.

### DETAILED DESCRIPTION

Next, one embodiment of a fuel cell system according to the present invention will be described. A case where this fuel cell system is applied to a vehicle-mounted power generation system of a fuel cell vehicle will be described. However, the present invention is not limited to such an application example, and can be applied to any type of mobile body such as a ship, an airplane or a train, or a biped robot. In addition, the present invention may be applied to, for example, a stationary power generation system in which a fuel cell is used as a power generation equipment for a construction (a housing, a building or the like).

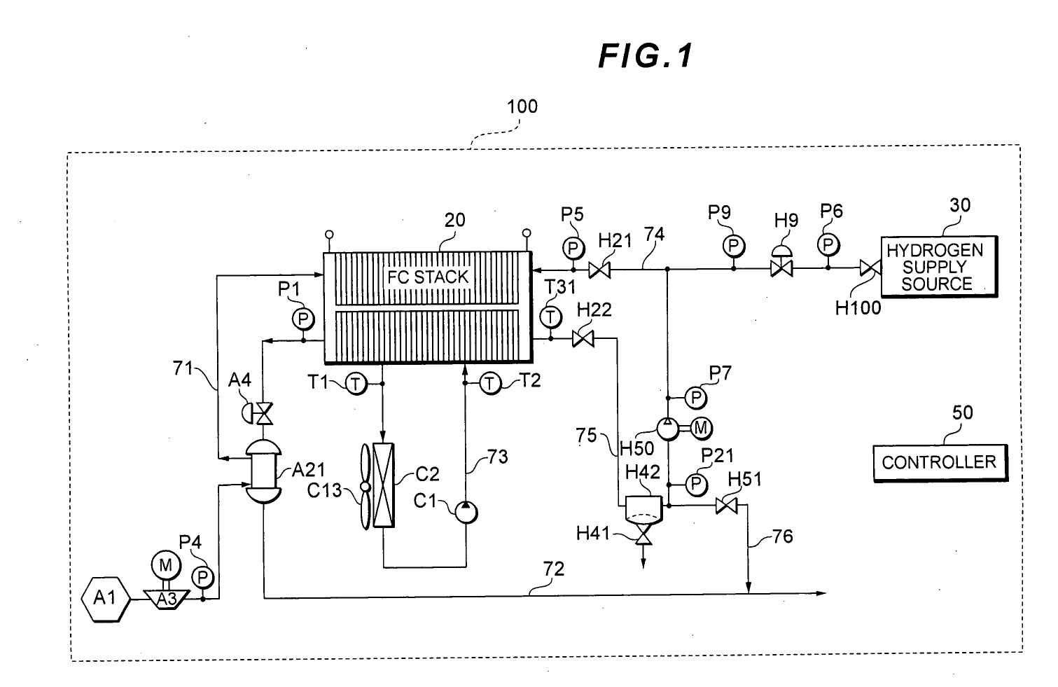

First, the whole constitution of a fuel cell system 100 according to the present embodiment will be described with reference to FIG. 1.

In this fuel cell system 100, air (outside air) as an oxidizing gas is supplied to an air supply port of a fuel cell 20 via an air supply path 71. The air supply path 71 is provided with an air filter A1, a compressor A3 which pressurizes air, a pressure sensor P4 which detects a supply air pressure, and a humidifier A21 which adds a desired water content to the air. The compressor A3 is driven by a motor (an auxiliary machine). This motor is driven and controlled by a controller 50 described later. It is to be noted that the air filter A1 is provided with an air flow meter (a flow rate meter) (not shown) which detects a flow rate of the air.

An air off gas discharged from the fuel cell 20 is discharged from the system via an exhaust path 72. The exhaust path 72 is provided with a pressure sensor P1 which detects an exhaust pressure, a pressure adjustment valve A4 and a heat exchanger of the humidifier A21. The pressure sensor P1 is provided in the vicinity of an air exhaust port of the fuel cell 20. The pressure adjustment valve A4 functions as a pressure adjuster (a pressure reducer) which sets a pressure of air to be supplied to the fuel cell 20.

Detection signals (not shown) of the pressure sensors P4, P1 are sent to the controller 50. The controller 50 adjusts a motor rotation number of the compressor A3 and an open degree of the pressure adjustment valve A4 to set the pressure and a flow rate of the air to be supplied to the fuel cell 20.

A hydrogen gas as a fuel gas is supplied from a hydrogen supply source (a fuel gas supply source) 30 to a hydrogen supply port of the fuel cell 20 via a fuel supply path (a fluid channel, a gas channel, a fuel gas supply channel) 74. The hydrogen supply source 30 corresponds to, for example, a high-pressure hydrogen tank, but instead of the tank, a reformer which generates a hydrogen-rich reformed gas from a hydrocarbon-based fuel, and a high-pressure gas tank which brings the reformed gas generated by this reformer into a high-pressure state to accumulate the pressure may be adopted as the hydrogen supply source. Alternatively, a tank having a hydrogen-gas absorbing alloy may be adopted as the hydrogen supply source.

The fuel supply path 74 is provided with a block valve H100 which supplies hydrogen from the hydrogen supply source 30 or which stops the supply, a pressure sensor P6 which detects a pressure of the hydrogen gas to be supplied from the hydrogen supply source 30, a regulating valve H9 which reduces and adjusts a pressure of the hydrogen gas to be supplied to the fuel cell 20, a pressure sensor P9 which detects a pressure of the hydrogen gas on a downstream side of the regulating valve H9, a block valve H21 which opens and closes between a hydrogen supply port of the fuel cell 20 and the fuel supply path 74, and a pressure sensor P5 which detects a pressure of the hydrogen gas at an inlet of the fuel cell 20. Detection signals (not shown) of the pressure sensors P5, P6 and P9 are supplied to the controller 50.

The hydrogen gas which has not been consumed in the fuel cell 20 is discharged as a hydrogen off gas to a hydrogen circulation path 75, and returned to the downstream side of the regulating valve H9 of the fuel supply path 74. The hydrogen circulation path 75 is provided with a temperature sensor T31 which detects a temperature of the hydrogen off gas, a block valve H22 which connects/blocks the fuel cell 20 to/from the hydrogen circulation path 75, a gas-liquid separator H42 which collects a water content from the hydrogen off gas, a discharge valve H41 which collects the formed and collected water in a tank (not shown) or the like outside the hydrogen circulation path 75, and a hydrogen pump H50 which pressurizes the hydrogen off gas.

The block valves H21, H22 close the fuel cell 20 on an anode side. A detection signal (not shown) of the temperature sensor T31 is supplied to the controller 50. An operation of the hydrogen pump H50 is controlled by the controller 50. The hydrogen off gas joins the hydrogen gas in the fuel supply path 74, is supplied to the fuel cell 20 and reused therein. The block valves H100, H21 and H22 are driven in response to a signal from the controller 50.

The hydrogen circulation path 75 is connected to the exhaust path 72 via a discharge control valve H51 and a purge channel 76. The discharge control valve H51 is an electromagnetic block valve, and operates based on a command from the controller 50 to discharge (purge) the hydrogen off gas from the system. This purge operation is intermittently performed to repeat circulation of the hydrogen off gas, whereby lowering of a cell voltage due to increase of a concentration of impurities in the hydrogen gas on a fuel pole side can be prevented.

A cooling water outlet/inlet of the fuel cell 20 is provided with a cooling path 73 for circulating cooling water. The cooling path 73 is provided with a temperature sensor T1 which detects a temperature of the cooling water discharged from the fuel cell 20, a radiator (a heat exchanger) C2 which releases heat from the cooling water, a cooling pump C1 for pressurizing the cooling water to circulate the water, and a temperature sensor T2 which detects a temperature of the cooling water to be supplied to the fuel cell 20. The radiator C2 is provided with a cooling fan C13 which is rotated and driven by a motor.

The fuel cell 20 is constituted as a fuel cell stack in which a predetermined number of unitary cells for receiving supply of the fuel gas and the oxidizing gas to generate a power are laminated.

The power generated by the fuel cell 20 is supplied to a power control unit (not shown). The power control unit includes an inverter which supplies the power to a driving motor of a vehicle, an inverter which supplies the power to various auxiliary machines such as a compressor motor and a motor for the hydrogen pump, a DC-DC converter which charges power accumulation means such as a secondary cell or which supplies the power from the power accumulation means to the motors and the like.

The controller 50 detects an operation amount of an acceleration operating device (an accelerator or the like) provided in the vehicle, and receives control information such as a demanded acceleration value (e.g., a demanded power generation amount from a load device such as the driving motor of the vehicle) to control operations of the units provided in the system.

It is to be noted that the load device is a generic power consumption device including the driving motor of the vehicle, additionally an auxiliary device (e.g., a motor of the compressor A3, the hydrogen pump H50 or the cooling pump C1) required for operating the fuel cell 20, an actuator for use in any type of device (a change gear, a wheel control device, a steering device, a suspension device or the like) associated with running of the vehicle, an air conditioning device (an air conditioner) of a passenger space, illumination or audio.

The controller 50 is constituted of a control computer system (not shown). This control computer system is constituted of a commercially available computer system for control having a known constitution including a CPU, an ROM, an RAM, an HDD, an input/output interface, a display and the like.

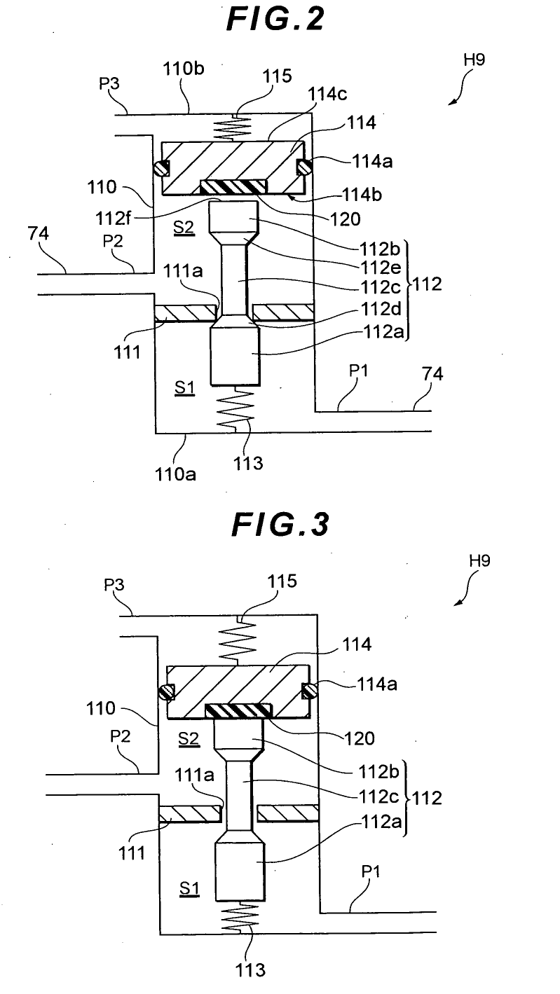

Next, a constitution and a function of the regulating valve H9 according to the present embodiment will be described in detail with reference to FIGS. 2 and 3.

The regulating valve H9 includes a cylinder 110 into which the hydrogen gas from the hydrogen supply source 30 is introduced, an inner partition wall 111 which divides the inside of the cylinder 110 into two spaces S1, S2 arranged in a longitudinal direction, a valve body 112 which opens/closes a through hole 111a formed in the inner partition wall 111, a first spring body 113 which urges the valve body 112 toward one side (a direction where a valve open degree is reduced) of the cylinder 110 in the longitudinal direction, a piston 114 which slides in the longitudinal direction of the cylinder 110 in the space S2, and a second spring body 115 which urges the piston 114 toward the other side (a direction where the valve open degree is enlarged) of the cylinder 110 in the longitudinal direction to displace the valve body 112.

The cylinder 110 on the side of the space S1 is provided with a primary port P1 which communicates with a primary side of the fuel supply path 74, that is, a hydrogen supply source 30 side. On the other hand, the cylinder on the side of the space S2 is provided with a secondary port P2 which communicates with a secondary side of the fuel supply path 74, that is, a fuel cell 20 side, and an air flow port P3 which releases a back pressure of the piston 114. A space of the piston 114 on the side of a back surface 114c in the cylinder 110 opens to the atmosphere through the air flow port P3.

The inner partition wall 111 is disposed at right angles with respect to the longitudinal direction of the cylinder 110. The through hole 111a is formed in a thickness direction of the inner partition wall 111 in the center of the inner partition wall 111.

The valve body 112 has a circular rod-like section, and a diameter of one end 112a and the other end 112b is formed to be larger than a diameter of an intermediate portion 112c positioned between the opposite ends 112a and 112b. A tapered portion 112d is formed between the one end 112a and the intermediate portion 112c, and a tapered portion 112e is formed between the other end 112b and the intermediate portion 112c.

The valve body 112 is inserted through the through hole 111a so that one end 112a is disposed on the space S1 side and the other end 112b is disposed on the space S2 side. In addition, the through hole 111a is larger than the diameter of the intermediate portion 112c of the valve body 112, but is smaller than the diameter of the opposite ends 112a, 112b. In the inner partition wall 111, a periphery of the one end 112a on which the tapered portion 112d abuts constitutes a valve seat.

The first spring body 113 is interposed between one end wall 110a of the cylinder 110 and the one end 112a of the valve body 112, and urges the valve body 112 from the space S1 toward the space S2.

The piston 114 is a thick disc having a diameter smaller than an inner diameter of the cylinder 110, and is disposed in the space S2 so as to match the center of the piston with that of the cylinder 110. An O-ring 114a is attached to an outer peripheral surface of the piston 114. The O-ring 114a slidably comes in contact under pressure with an inner wall of the cylinder 110, and receives the hydrogen gas so as to prevent leak of the hydrogen gas toward the air flow port P3. The piston 114 can be guided along an inner side surface of the cylinder 110 to slide together with the O-ring 114a in the longitudinal direction of the cylinder 10.

The second spring body 115 is interposed between the other end wall 110b of the cylinder 110 and the back surface 114c of the piston 114, and urges the piston 114 from the space S2 toward the space S1.

An end surface 114b of the piston 114 which faces the valve body 112, and an end surface 112f of the other end 112b of the valve body 112 which faces the piston 114 is disposed so as to form right angles with respect to the longitudinal direction of the cylinder 110 in the same manner as in the inner partition wall 111. That is, the end surface 114b of the piston 114 is disposed in parallel with the end surface 112f of the valve body 112.

The end surface (an abutment portion) 114b of the piston 114 is provided with a rubber member (an impact absorbing member) 120. The rubber member 120 is fitted into a recessed portion formed in the center of the end surface 114b on the same plane as that of the end surface 114b. A region in which the rubber member 120 is disposed is set to be larger than a region which abuts on the end surface 112f of the valve body 112. As the rubber member 120, a material (e.g., an ethylene propylene rubber (EPDM), silicon or the like) which is not easily deteriorated even in the hydrogen gas at a remarkably low temperature is selected.

In the regulating valve H9 having the above constitution, an inner pressure (i.e., the pressure of the hydrogen gas on the primary side of the fuel supply path 74) of the space S1, an inner pressure (i.e., the pressure of the hydrogen gas on the secondary side of the fuel supply path 74) of the space S2, an urging force of the first spring body 113 and an urging force of the second spring body 115 are balanced, whereby the valve body 112 adjusts the hydrogen gas supplied from the hydrogen supply source 30 into a predetermined pressure.

When the inner pressure of the space S2 is lower than the predetermined pressure, a force (the pressure of the hydrogen gas x an area of the end surface 114b) with which the hydrogen gas in the space S2 pushes the end surface 114b of the piston 114 becomes smaller than an urging force of the second spring body 115, so that the piston 114 is displaced from the space S2 toward the space S1 to abut on the other end 112b of the valve body 112, thereby displacing the valve body 112 in the same direction. That is, as shown in FIG. 3, when the inner pressure of the space S2 is lower than the predetermined pressure, the valve body 112 disposes the tapered portion 112d on the one end 112a side away from the through hole 111a of the inner partition wall 111 to open the through hole 111a.

On the other hand, when the inner pressure of the space S2 is higher than the predetermined pressure, the force with which the hydrogen gas in the space S2 pushes the end surface 114b of the piston 114 becomes larger than the urging force of the second spring body 115, so that the piston 114 is displaced from the space S1 toward the space S2 to come away from the other end 112b of the valve body 112. That is, as shown in FIG. 2, when the inner pressure of the space S2 is higher than the predetermined pressure, the valve body 112 presses the tapered portion 112d on the one end 112a side onto the through hole 111a of the inner partition wall 111 to close the through hole 111a.

In addition, in the regulating valve H9, consumption of the hydrogen gas in the fuel cell 20 rapidly increases, and the pressure of the hydrogen gas in the fuel supply path 74 positioned on the downstream side from the regulating valve H9, that is, the fuel cell 20 side lowers. In this case, the piston 114 is urged by the second spring body 115, and is: rapidly displaced toward the valve body 112, whereby the other end 112b of the valve body 112 sometimes collides with the piston 114.

According to the regulating valve H9 of the present embodiment, the rubber member 120 is provided as the impact absorbing member in an abutment portion between the valve body 112 and the piston 114, so that impact at a time when the other end 112b of the valve body 112 collides with the piston 114 is relaxed. Therefore, generation of wear and deformation of the valve body 112 can be inhibited. In addition, noise and vibration generated at a time when the valve body 112 collides with the piston 114 can be reduced.

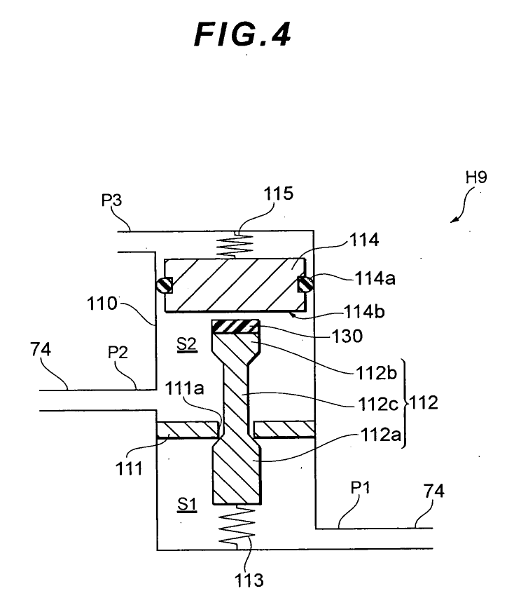

The above embodiment is merely illumination to describe the present invention, and the present invention is not limited to this embodiment. Various constituting components can appropriately be designed without departing from the scope of the invention. For example, as shown in FIG. 4, instead of a piston 114, a tip (an abutment portion) of the other end 112b of a valve body 112 may be provided with a rubber member 130 as an impact absorbing member. Alternatively, the piston 114 may be provided with a rubber member 120, and the valve body 112 may be provided with the rubber member 130.

Furthermore, a regulating valve having the same function as that of the regulating valve H9 may be provided in not only the fuel supply path 74 but also the air supply path 71 positioned between the humidifier A21 and the fuel cell 20, the exhaust path 72 positioned between the fuel cell 20 and the humidifier A21 and the hydrogen circulation path 75 positioned between the fuel cell 20 and the gas-liquid separator H42.

1. A regulating valve which is installed in a gas channel where a hydrogen gas accumulated at a high pressure or a hydrogen-rich reforming gas is supplied, to adjust a gas pressure, comprising, in a cylinder into which a fluid is introduced:
a piston which is displaced in a predetermined direction at a time when the gas pressure on a downstream side from the cylinder becomes smaller than a predetermined pressure;
a valve body which abuts on the piston at a time when the piston is displaced in the predetermined direction, whereby the valve body is pushed by the piston, and is displaced to change a valve open degree; and
an impact absorbing member provided in an abutment portion between the piston and the valve body,
wherein the impact absorbing member is constituted of a material which does not easily deteriorate even when placed in the gas at a remarkably low temperature.

2. (canceled)

3. A fuel cell system comprising:
a fuel cell which receives gas supply to generate a power; and a gas channel through wich a gas to be supplied to or discharged from the fuel cell flows,
wherein the regulating valve according to claim 1 is installed in a fuel gas supply channel which supplies, to the fuel cell, a fuel gas accumulated at a high pressure in the gas channel.

4. The regulating valve according to claim 1, wherein the impact absorbing member is made of ethylene propylene rubber or silicon.

5. A fuel cell system comprising:
a fuel cell which receives gas supply to generate a power; and
a gas channel through which a gas to be supplied to or discharged from the fuel cell flows,
wherein the regulating valve according to claim 2 is installed in a fuel gas supply channel which supplies, to the fuel cell, a fuel gas accumulated at a high pressure in the gas channel.
